(19) United States
(12) Patent Application Publication
(10) Pub. No.: US 2005/0235438 A1
(43) Pub. Date: Oct. 27, 2005

(54) Power toothbrush

(76) Inventors: Ryo Motohashi, Kadoma-shi (JP); Tomohiro Kunita, Kadoma-shi (JP); Shinichi Taniguchi, Kadoma-shi (JP); Katsuhiro Hirata, Kadoma-shi (JP); Yuya Hasegawa, Kadoma-shi (JP)

Correspondence Address: GREENBLUM & BERNSTEIN, P.L.C., 1950 ROLAND CLARKE PLACE, RESTON, VA, 20191, US

(21) Appl. No.: 10/525,526

(22) PCT Filed: Nov. 20, 2003
(86) PCT No.: PCT/JP03/14858

§ 371 Date: Feb. 24, 2005

(30) Foreign Application Priority Data
Nov. 26, 2002 (JP) 2002-341720

(51) Int. Cl. A61C 17/22

(52) U.S. Cl. 15/22.1

(57) ABSTRACT

In a power toothbrush, an interchangeable brush head is directly fitted to a front end portion of a drive shaft of an actuator. The actuator comprises a first magnetic circuit for moving the drive shaft reciprocally in an axial direction of the drive shaft, and a second magnetic circuit for rotating the drive shaft around a center axis of the drive shaft. The first magnetic circuit and the second magnetic circuit are independently excited by independent driving current having predetermined frequencies and a predetermined phase difference therebetween. Thus, the brush head fitted to the drive shaft can be moved in a composition of reciprocal linear movement and reciprocal rotation. The actuator does not include conventional mechanical elements such as gears or cams so that the actuator can move the drive shaft much faster than that of the conventional actuator.

### TECHNICAL FIELD

The present invention relates to a power toothbrush, and especially relates to an actuator for reciprocally moving a brush head in an axial direction of a drive shaft and for reciprocally rotating the brush head around a center axis of the drive shaft.

### BACKGROUND ART

In a conventional power toothbrush, for example, shown in publication of Japanese patent application 9-173360, rotation of a drive shaft of a motor is converted to reciprocal linear motion or reciprocal rotation by a motion converting mechanism. A brush head fitted on a drive shaft of the motion converting mechanism is reciprocally moved in an axial direction of the drive shaft or reciprocally rotated around a center axis of the drive shaft.

The conventional power toothbrush, however, uses a cam in the motion converting mechanism for converting the continuous rotation of the drive shaft of the motor to reciprocal linear movement or reciprocal rotation of the drive shaft of the motion converting mechanism. Thus, it is difficult to move the drive shaft of the motion converting mechanism in a high speed, so that there is a limit to increase an effect for removing dental plaque.

### DISCLOSURE OF INVENTION

A purpose of the present invention is to solve the above-mentioned problem and to provide a power toothbrush which can move a drive shaft of a driving mechanism and a brush head fitted to the drive shaft in a high speed so that an effect for removing dental plaque can be increased.

For accomplishing the above-mentioned purpose, a power toothbrush in accordance with an aspect of the present invention comprises a brush head and an actuator for moving the brush head. The actuator further comprises a drive shaft to which the brush head is fitted, a first magnetic circuit for reciprocally moving the drive shaft in an axial direction thereof, and a second magnetic circuit for reciprocally rotating the drive shaft around a center axis thereof. The first magnetic circuit and the second magnetic circuit directly move the drive shaft.

By such a configuration, the drive shaft is directly driven by the first magnetic circuit and the second magnetic circuit without intervening mechanical elements such as a cam and/or gears. Thus, efficiencies for transmitting driving forces from the first magnetic circuit and the second magnetic circuit to the drive shaft can be increased, so that the drive shaft can be driven in a high speed.

Furthermore, the drive shaft is driven by not only the first magnetic circuit in the axial direction thereof but also the second magnetic circuit around the center axis thereof. Thus, the motion of the brush head is not limited to only one of the reciprocal linear motion and the reciprocal rotation differ from the conventional power toothbrush. The brush head can be moved in a complex motion in combination with the reciprocal linear motion and the reciprocal rotation. As a result, an efficiency for removing dental plaque by the power toothbrush can be increased.

### BRIEF DESCRIPTION OF DRAWINGS

FIG. 1 is a sectional side view for showing a configuration of a power toothbrush in accordance with an embodiment of the present invention;

FIG. 2 is a perspective view for showing a detailed configuration of an actuator of the power toothbrush;

FIG. 3 is a perspective view for showing a configuration of a first magnetic circuit of the actuator;

FIG. 4 is a perspective view for showing a configuration of a second magnetic circuit of the actuator; and

FIG. 5 is a table for showing trails a brush head driven in combination of bass motion and rolling motion under several conditions.

### BEST MODE FOR CARRYING OUT THE INVENTION

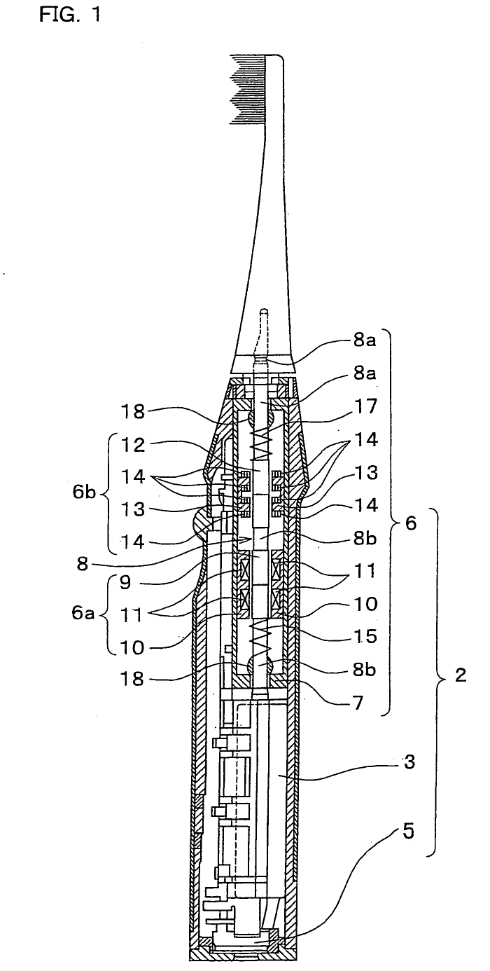

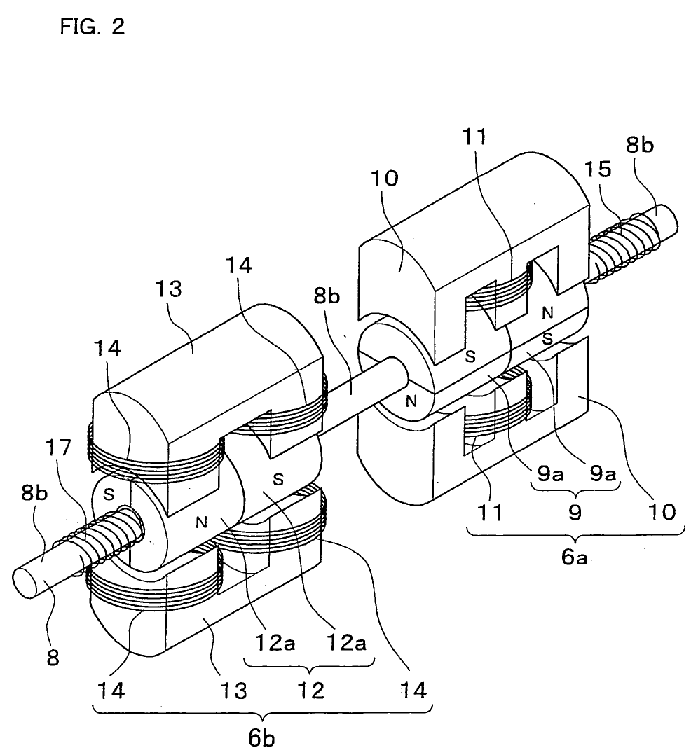

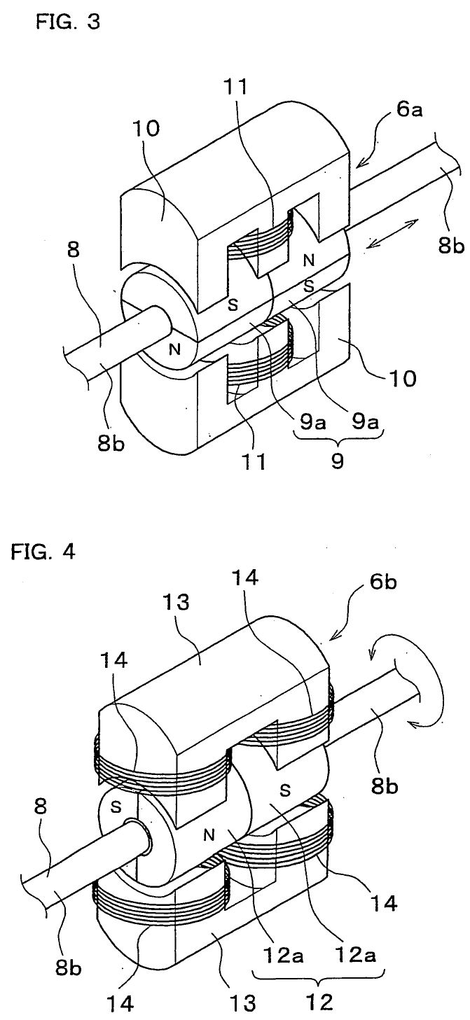

An embodiment of the present invention is described with reference to the drawings. FIG. 1 shows a configuration of a power toothbrush. FIG. 2 shows a detailed configuration of an actuator of the power toothbrush. FIG. 3 shows a first magnetic circuit in the actuator. FIG. 4 shows a second magnetic circuit in the actuator.

As can be seen from FIG. 1, the power toothbrush comprises a brush head 1 and a main body (grip portion) 2. The main body 2 further comprises an actuator 6 for moving the brush head 1, a controller (not shown) for controlling the actuator 6, a secondary cell (battery) 3, an inverter (not shown) for generating driving currents, a charging unit 5 for charging the secondary cell 3, and so on.

The actuator 6 further comprises a drive shaft 8, a first magnetic circuit 6a, a second magnetic circuit 6b, two coil springs 15 and 17. The substance of the actuator 6 is contained in a tubular casing 7. A front end portion 8a of the drive shaft 8 is protruded from the casing 7. The brush head 1 is fitted to the protruded front end portion 8a of the drive shaft 8.

As can be seen from FIG. 2, a first permanent magnet unit 9 and a second permanent magnet unit 12 are provided on a main portion 8b of the drive shaft 8 with a predetermined distance.

The first magnetic circuit 6a is configured by the first permanent magnet unit 9, a pair of first stators 10 disposed for facing the first permanent magnet unit 9 with predetermined gaps, and a pair of first windings 11 which is wound around the first stators 10.

The first permanent magnet unit 9 is configured by two cylindrical permanent magnets 9a. Each cylindrical permanent magnet 9a is magnetized in a radial direction thereof. The cylindrical permanent magnets 9a are tightly fixed around the main portion 8b of the drive shaft 8 in a manner so that magnetic poles of one cylindrical permanent magnet 9a are quite contrary to the magnetic poles of the other.

Each of the first stators 10 has substantially E-shaped section. The first stators 10 are disposed symmetrical with respect to the first permanent magnet unit 9 in a manner so that three poles of one of the first stators 10 respectively face three poles of the other intervening the first permanent magnet unit 9. Each first winding 11 is wound around a center pole of each first stator 10. By supplying a driving current to the first windings 11, the first stators 10 are excited. In the inactivated state of the actuator 6, the first permanent magnet unit 9 is stopped in a manner so that lines of magnetic force owing to the cylindrical permanent magnets 9a are oriented in a direction parallel to protrusion of poles of the first stators 10 facing each other. When the driving current is supplied to the first windings 11, the first magnetic circuit 6a is excited for moving the first permanent magnet unit 9 with the drive shaft 8 in the axial direction of the drive shaft 8. Hereinafter, the reciprocal linear movement in the axial direction of the drive shaft 8 is called “bass motion”.

The second magnetic circuit 6b is configured by the second permanent magnet unit 12, a pair of second stators 13 disposed for facing the second permanent magnet unit 12 with predetermined gaps, and two pairs of second windings 14 which are wound around the second stators 13.

The second permanent magnet unit 12 is configured by two cylindrical permanent magnets 12a. Each cylindrical permanent magnet 12a is magnetized in a radial direction thereof. The cylindrical permanent magnets 12a are tightly fixed around the main portion 8b of the drive shaft 8 in a manner so that magnetic poles of one cylindrical permanent magnet 12a are quite contrary to the magnetic poles of the other. Furthermore, the second permanent magnet unit 12 is fixed on the drive shaft 8 in a manner so that the direction of magnetization of the second permanent magnet unit 12 crosses substantially at right angle with the direction of the magnetization of the first permanent magnet unit 9.

Each of the second stators 13 has substantially channel iron shaped section. The second stators 13 are disposed symmetrical with respect to the second permanent magnet unit 12 in a manner so that two poles of one of the second stators 13 respectively face two poles of the other intervening the second permanent magnet unit 12. A pair of the second windings 14 are respectively wound around respective poles of each second stator 13. By supplying a driving current to the second windings 14, the second stators 13 are excited. In the inactivated state of the actuator 6, the second permanent magnet unit 12 is stopped in a manner so that lines of magnetic force owing to the cylindrical permanent magnets 12a are oriented in a direction perpendicular to protrusion of poles of the second stators 13 facing each other. When the driving current is supplied to the second windings 14, the second magnetic circuit 6b is excited for rotating the second permanent magnet unit 12 with the drive shaft 8 around the center axis of the drive shaft 8. Hereinafter, the reciprocal rotation around the center axis of the drive shaft 8 is called “rolling motion”.

As shown in FIGS. 1 and 2, the coil springs 15 and 17 are respectively engaged with the main portion 8b of the drive shaft 8 in the vicinity of both ends of the main portion 8b. A pair of bearings 18 are provided at both ends of an inner cavity of the casing 7, so that the drive shaft 8 is pivoted not only rotatable around the center axis thereof but also linearly movable in axial direction thereof. The upper coil spring 17 is disposed between the upper bearing 18 and the second permanent magnet unit 12 for applying a downward pressing force to the second permanent magnet unit 12. The lower coil spring 15 is disposed between the lower bearing 18 and the first permanent magnet unit 9 for applying an upward pressing force to the first permanent magnet unit 9.

Subsequently, the motion of the power toothbrush is described. Alternating currents as the driving currents are flown in the first windings 11 and the second windings 14 of the actuator 6 corresponding to control signals from the controller. Frequencies of and a phase difference between the alternating currents are adjustable corresponding to operations of control switches or knobs by a user. For example, four control switches or knobs are provided so that four parameters of frequencies and phases of two alternating currents respectively flown in the first windings 11 and the second windings 14 are independently adjustable. It, however, is possible to supply an alternating current to alternative of the first windings 11 and the second windings 14 by adjusting the control switches or knobs selectively.

The first stators 10 are excited corresponding to the timing of flowing the alternating current in the first windings 11. The directions of excitation in the first stators 10 are alternated corresponding to variation of the polarity (+ and −) of the alternating current. Thus, the first permanent magnet unit 9 is reciprocally and linearly moved with the drive shaft 8 in the axial direction of the drive shaft 8 (bass motion). Similarly, the second stators 13 are excited corresponding to the timing of flowing the alternating current in the second windings 14. Thus, the second permanent magnet unit 12 is reciprocally rotated with the drive shaft 8 around the center axis of the drive shaft 8 (rolling motion). Accordingly, the drive shaft 8 and the brush head 1 fitted to the drive shaft 8 are moved as a composition of the bass motion of the first permanent magnet unit 9 and the rolling motion of the second permanent magnet unit 12.

The timings for flowing the alternating currents in the first windings 11 and the second windings 14 are not illustrated, but they can be controlled by the controller corresponding to the selection of the frequencies and the phases (or a phase difference) of the alternating currents.

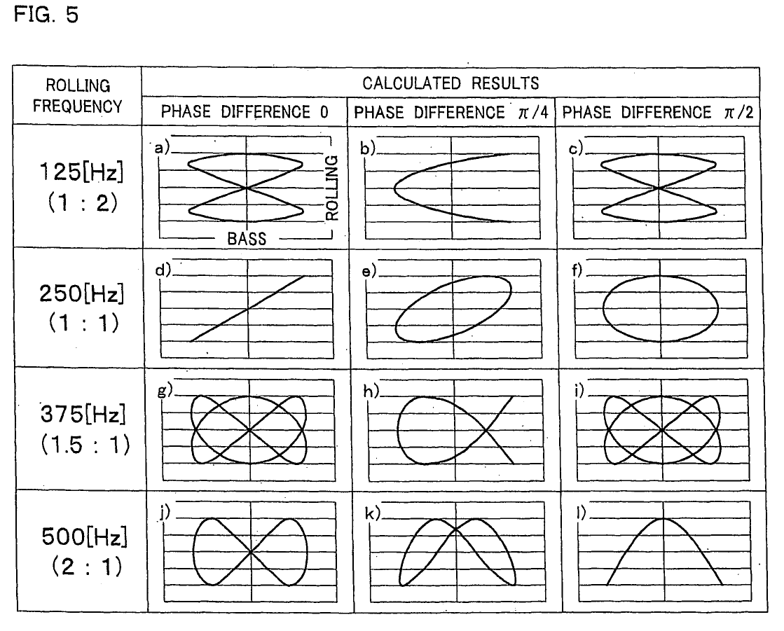

FIG. 5 shows a table of trails of the motion of the brush head 1 when the actuator 6 is driven in combination with the bass motion and the rolling motion under several conditions in which the frequencies of and the phase difference between the alternating currents flown in the first windings 11 and the second windings 14 are varied. In FIG. 5, abscissas designate strokes of the drive shaft 8 in the bass motions, and ordinates designate rotation angles of the drive shaft 8 in the rolling motions. The frequencies of the alternating currents in the bass motions are to be constant value of 250 Hz.

With respect to the trails illustrated in the boxes designated by symbols (d), (e) and (f), the brush head 1 is moved in the bass motion and the rolling motion by the actuator 6, in which the alternating currents flown in both of the first windings 11 and the second windings 14 have the same frequency. In such cases, the brush head 1 is surely shuttled in both of the bass motion and the rolling motion in one period of alternating currents. Thus, it is possible to brush not only dental necks but also interdentium between the dental necks by the brush head 1 in each period, so that dental plaque can surely be removed from the dental necks and the interdentium.

With respect to the trails illustrated in the boxes designated by symbols (j), (k) and (l), the brush head 1 is moved in the bass motion and the rolling motion by the actuator 6, in which the frequencies of the alternating currents flown in the second wirings 14 for the rolling motion are respectively an integral multiple, for example, twofold of the frequencies of the alternating currents flown in the first wirings 11 for the bass motion. In such cases, the brush head 1 is shuttled in the rolling motion at integral multiple times, for example, twice in these examples while the brush head 1 is shuttled in the bass motion once. Thus, dental plaque can be removed from the interdentium more effectively.

With respect to the trails illustrated in the boxes designated by symbols (a), (b) and (c), the brush head 1 is moved in the bass motion and the rolling motion by the actuator 6, in which the frequencies of the alternating currents flown in the first wirings 11 for the bass motion are respectively an integral multiple, for example, twofold of the frequencies of the alternating currents flown in the second wirings 14 for the rolling motion. In such cases, the brush head 1 is shuttled in the bass motion at integral multiple times, for example, twice in these examples while the brush head 1 is shuttled in the rolling motion once. Thus, dental plaque can be removed from the dental necks more effectively.

With respect to the trails illustrated in the boxes designated by symbols (g), (h) and (i), the brush head 1 is moved in the bass motion and the rolling motion by the actuator 6, in which the frequencies of the alternating currents flown in the second wirings 14 for the rolling motion are respectively not an integral multiple, for example, time and a half of the frequencies of the alternating currents flown in the first wirings 11 for the bass motion. In such cases, the motion of the brush head 1 becomes at random, so that dents can be cleaned from various angles unconsciously. Thus, dental plaque is not remained so much in a portion where the moving brush head 1 is moved.

With respect to the trails illustrated in the boxes designated by symbols (a), (d), (g) and (j), the bass motion and the rolling motion of the brush head 1 are in phase, so that the trail of the motion of the brush head 1 mainly passes an initial position where the brush head 1 is stopped when the actuator 6 is inactivated. Thus, dental plaque can be removed in a predetermined portion intensively.

With respect to the trails illustrated in the boxes designated by symbols (b), (e), (h) and (k), the phase of the bass motion is discrepant by π/4 from the phase of the rolling motion, so that the trail of the motion of the brush head 1 does not pass the initial position. By switching the motion of the brush head 1 between the above-mentioned the bass motion and the rolling motion in phase and the bass motion and the rolling motion with a phase difference, the brush head 1 can be moved in various trails, so that dental plaque can effectively be removed in every portion where the brush head passes. Such the effect can be obtained in a case in which the phase difference between the bass motion and the rolling motion takes any optional value except π/2.

For reducing the possibility that the moving brush head 1 is not contacted with gums, it is preferable to make the stroke of the brush head 1 in the bass motion equal to or shorter than 4 mm. Similarly, it is preferable to make the angle of reciprocal rotation of the brush head in the rolling motion equal to or smaller than 20 degrees.

As mentioned above, the power toothbrush in accordance with this embodiment can move the drive shaft 8 and the brush head 1 fitted to the drive shaft 8 by controlling the frequencies of and the phase difference between the alternating currents flown in the first windings 11 of the first magnetic circuit 6a and the second windings 14 of the second magnetic circuit 6b, without using any mechanical elements such as a cam or gears. In comparison with the conventional power toothbrush using the mechanical elements for driving the brush head, it is possible to move the drive shaft 8 and the brush head 1 reciprocally in a shorter period by the power toothbrush in accordance with this embodiment. Specifically, an upper limit of the frequency of the reciprocal motion of the brush head in the conventional power toothbrush using the cam or the gears is about 100 Hz. On the other hand, the reciprocal motion of the brush head 1 of the power toothbrush in accordance with this embodiment can be driven in a frequency higher than at least 100 Hz. Thus, the drive shaft 8 and the brush head 1 can be reciprocally moved in a speed much higher by the first and second magnetic circuits 6a and 6b as the actuator 6 of the power toothbrush in accordance with this embodiment. As a result, the efficiency for removing dental plaque by the power toothbrush can be increased.

When the frequency for driving the drive shaft 8 and the brush head 1 is increased, the stroke of the drive shaft 8 in the bass motion or in the rolling motion becomes smaller corresponding to the increase of the frequency. Thus, the possibility that the moving brush head 1 is contacted with gums can be reduced by increasing the frequency of the reciprocal motion of the brush head 1. Furthermore, the friction between the brush head 1 and dents is reduced corresponding to the increase of the frequency of the reciprocal motion of the brush head 1, so that it is possible to clean the dents sensitively. Thus, it is possible to clean the dents sensitively and effectively by selecting the frequency of the reciprocal motion of the brush head 1. Specifically, it is possible to select the frequency of the reciprocal motion of the brush head 1 in a region between 100 Hz to 350 Hz.

Furthermore, the actuator 6 comprises the first magnetic circuit 6a for moving the drive shaft 8 in the bass motion and the second magnetic circuit 6b for moving the drive shaft 8 in the rolling motion. Thus, the drive shaft 8 and the brush head 1 fitted to the drive shaft 8 can be driven in not only the bass motion but also the rolling motion, simultaneously. In comparison with the conventional power toothbrush in which the brush head can be driven in alternative of the bass motion and the rolling motion, the motion of the brush head 1 of the power toothbrush in accordance with this embodiment becomes more complex. Thus, the effect for removing dental plaque can be increased.

Still furthermore, the frequencies and the phases of the alternating currents flown in the first windings 11 and the second windings 14 can be varied by adjusting the control switches or knobs. Thus, the brush head 1 can be moved for taking various trails as mentioned above. The brush head 1 can be contacted to dents in various directions, so that dental plaque can effectively removed from the dents.

The above-mentioned configuration of the power toothbrush in accordance with this embodiment can be modified as follows.

The main portion 8b of the drive shaft 8 is divided into two parts, one of which can be slidable with respect to the other in the axial direction of the drive shaft 8 but integrally rotatable around the center axis of the drive shaft 8. The first permanent magnet unit 9 is fixed on one of the divided parts and the second permanent magnet unit 12 is fixed on the other. Alternatively, the first permanent magnet unit 9 is fixed on the main portion 8b of the drive shaft 8, and the second permanent magnet unit 12 is slidable with respect to the main portion 8b in axial direction of the drive shaft 8 but integrally rotatable with the drive shaft 8. In both cases, the first permanent magnet unit 9 and the second permanent magnet unit 12 are coupled by a coil spring. By such the configurations, the front end portion 8a of the drive shaft 8 can be moved in the bass motion corresponding to the reciprocal linear motion of the first permanent magnet unit 9, and in the rolling motion corresponding to the reciprocal rotation of the second permanent magnet unit 12. Vibrations due to reciprocal linear movement of the first permanent magnet unit 9 in the axial direction of the drive shaft 8, however, are rarely transmitted to the second permanent magnet unit 12, since the vibrations are attenuated by the intervening coil spring. As a result, vibrations of the main body 2 of the power toothbrush can be reduced, so that the user can brush dents comfortably.

IN the above-mentioned description, the alternating currents are supplied to the first windings 11 of the first magnetic circuit 6a and the second windings 14 of the second magnetic circuit 6b as the driving currents. It, however, is possible to supply pulsating currents having predetermined frequencies and a predetermined phase difference therebetween to the first windings 11 and the second windings 14 as the driving currents instead of supplying the alternating currents. By such a configuration, directions of magnetization in the first stators 10 of the first magnetic circuit 6a and the second stators 13 of the second magnetic circuit 6b can be switched periodically, too.

Furthermore, the frequencies of and the phase difference between the alternating currents or pulsating currents supplied to the first windings 11 and the second windings 14 are not restricted by the above-mentioned exemplified values. It is possible to select the values of the frequencies of and the phase difference between the alternating currents or pulsating currents freely corresponding to sensitive feeling of the user.

Still furthermore, alternating currents or pulsating currents are not necessarily supplied to the first windings 11 and the second windings 14, simultaneously. It is possible to supply the alternating currents or pulsating currents to alternative of the first windings 11 and the second windings 14. By such a configuration, the drive shaft 8 and the brush head 1 can be moved in alternative of the bass motion and the rolling motion, similar to the conventional power toothbrush.

Still furthermore, it is possible periodically switching on and off for supplying a driving current to the first windings 11 for moving the first permanent magnet unit 9 in the bass motion. When the driving current is flown in the first windings 11, the first permanent magnet unit 9 is moved in the axial direction of the drive shaft 8 by magnetic force, and the coil springs 15 and 17 are elastically deformed and vibrates sympathetically. When the driving current is switched off, the magnetic force acting on the first permanent magnet unit 9 is erased, but the first permanent magnet unit 9 continues the reciprocal linear motion in the axial direction of the drive shaft 8 owing to the sympathetic vibration of the coil springs 15 and 17. In other words, it is possible reciprocally to move the first permanent magnet unit 9 and the drive shaft 8 in the axial direction of the drive shaft by periodically repeating switching on and off for supplying the driving current to the first windings 11. Similarly, it is possible periodically switching on and off for supplying a driving current to the second windings 14 for rotating the second permanent magnet unit 12 in the rolling motion.

Still furthermore, four parameters of the frequencies and the phases of two alternating currents or pulsating currents respectively supplied to the first windings 11 and the second windings 14 are not necessarily independently adjustable. A plurality of parameters, for example, two frequencies of the alternating currents can be adjusted together.

Still furthermore, it is possible that the frequencies and the phases of two alternating currents or pulsating currents respectively supplied to the first windings 11 and the second windings 14 are previously fixed without providing the control switches or knobs.

This application is based on Japanese patent application 2002-341720 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

### INDUSTRIAL APPLICABILITY

As mentioned above, the power toothbrush in accordance with the present invention can move the brush head in a composition of the bass motion and the rolling motion, so that dental plaque can effectively removed from dents.

1. A power toothbrush comprising a brush head and an actuator for moving the brush head, wherein
the actuator further comprises a drive shaft to which the brush head is fitted, a first magnetic circuit for reciprocally moving the drive shaft in an axial direction thereof, and a second magnetic circuit for reciprocally rotating the drive shaft around the center axis thereof, and
the first magnetic circuit and the second magnetic circuit directly move the drive shaft.

2. The power toothbrush in accordance with claim 1, wherein
the first magnetic circuit and the second magnetic circuit can be activated, simultaneously.

3. The power toothbrush in accordance with claim 1, wherein
alternative of the first magnetic circuit and the second magnetic circuit can be activated.

4. The power toothbrush in accordance with claim 1, further comprising:
an inverter for generating two driving currents having predetermined frequencies and a phase difference therebetween, and supplied to the first magnetic circuit and the second magnetic circuit.

5. The power toothbrush in accordance with claim 4, wherein
the driving currents are alternating currents or pulsating currents.

6. The power toothbrush in accordance with claim 4, wherein
the frequencies of and/or the phase difference between the driving currents supplied to the first magnetic circuit and the second magnetic circuit are/is adjustable.

7. The power toothbrush in accordance with claim 4, wherein
the driving currents supplied to the first magnetic circuit and the second driving circuit are in phase.

8. The power toothbrush in accordance with claim 4, wherein
the phase difference between the driving currents supplied to the first magnetic circuit and the second driving circuit is π/2 or π/4.

9. The power toothbrush in accordance with claim 4, wherein
a frequency of a driving current supplied to the first magnetic circuit is equal to or an integral multiple of a frequency of a driving current supplied to the second magnetic circuit.

10. The power toothbrush in accordance with claim 4, wherein
a frequency of a driving current supplied to the second magnetic circuit is equal to or an integral multiple of a frequency of a driving current supplied to the first magnetic circuit.

11. The power toothbrush in accordance with claim 4, wherein
a ratio of a larger one in the frequencies of the driving currents supplied to the first magnetic circuit and the second driving circuit with respect to a smaller one of them is not an integer.

12. The power toothbrush in accordance with claim 1, wherein
the first magnetic circuit further comprises a first permanent magnet unit fixed on the drive shaft, a pair of first stators and a pair of first winding respectively wound around the first stators;
the second magnetic circuit further comprises a second permanent magnet unit fixed on the drive shaft, a pair of second stators and two pairs of second winding respectively wound around poles of the second stators;
the first permanent magnet unit is linearly moved in the axial direction of the drive shaft while a driving current is supplied to the first windings; and
the second permanent magnet unit is rotated around the center axis of the drive shaft while a driving current is supplied to the second windings.

13. The power toothbrush in accordance with claim 12, further comprising
a pair of coil springs for applying pressing forces for positioning the first permanent magnet unit and the second permanent magnet unit at initial positions while the actuator is not activated.

14. The power toothbrush in accordance with claim 13, wherein
the first magnetic circuit is periodically driven by switching on and off of supplying driving current; and
the reciprocal movement of the drive shaft in the axial direction is sustained owing to sympathetic vibrations of the coil springs while the driving current is not supplied to the first magnetic circuit.

15. The power toothbrush in accordance with claim 13, wherein
the second magnetic circuit is periodically driven by switching on and off of supplying driving current; and
the reciprocal rotation of the drive shaft around the center axis of the drive shaft is sustained owing to sympathetic vibrations of the coil springs while the driving current is not supplied to the second magnetic circuit.
